(19) United States
(12) Patent Application Publication
(10) Pub. No.: US 2025/0270864 A1
(43) Pub. Date: Aug. 28, 2025

(54) Appliance Lid Hinge

(71) Applicant: Mansfield Engineered Components, LLC, Mansfield, OH (US)

(72) Inventors: James J. Collene, Bucyrus, OH (US); Nicholas R. SirLouis, Seville, OH (US)

(73) Assignee: Mansfield Engineered Components, LLC, Mansfield, OH (US)

(21) Appl. No.: 19/040,542

(22) Filed: Jan. 29, 2025

Related U.S. Application Data
(60) Provisional application No. 63/626,524, filed on Jan. 29, 2024.

(51) Int. Cl. E05F 3/20; E05D 3/12

(52) U.S. Cl. CPC E05F 3/20; E05D 3/12; E05Y 2900/30

(57) ABSTRACT

An appliance lid hinge includes a base and an arm connected to the base. An arm control system includes a spring rod that moves relative to the base. A spring exerts a biasing force on the spring rod that urges the spring rod toward an extended position, and the spring rod is movable against the biasing force toward a retracted position. The arm is engaged with the spring rod through a linkage such that: (i) movement of the arm in an opening direction corresponds with movement of the spring rod toward the extended position; and, (ii) pivoting movement of the arm in a closing direction corresponds with movement of the spring rod toward the retracted position. An optional damper can be connected to the base and can exert a damping force on the spring rod or other part of the arm control system.

### CROSS-REFERENCE TO RELATED APPLICATION

This application claims priority from and benefit of the filing date of U.S. Provisional Application Ser. No. 63/626,524 filed Jan. 29, 2024, and the entire disclosure of said provisional application is hereby expressly incorporated by reference into the present specification.

### BACKGROUND

Appliance lid hinge assemblies that operatively connect a cover or lid to a body must provide the desired operational characteristics and durability while fitting into a confined space that often has an irregular shape. Furthermore, these hinge assemblies are subjected to heavy use, temperature variations, moisture, vibrations, and other harsh operating conditions, and are nonetheless expected to last for many years without requiring maintenance or repair.

Furthermore, consumers expect appliance lids to have a certain “feel” during opening and closing. For example, the appliance lid must be self-supporting when located in an opened position, even when the lid cannot be opened fully to 90 degrees or more due to an overhead obstruction. Consumers also often desire that the force required to open the lid not be excessive to accommodate people with limited strength or dexterity. In addition, it is becoming increasingly desirable by consumers for such appliance lids to exhibit a soft-close or slow-close characteristic in which the lid closes in a slow, controlled manner even when the lid closes under its own weight by force of gravity.

### SUMMARY

In accordance with one aspect of the present development, an appliance lid hinge assembly includes a base and an arm pivotally connected to the base and adapted to be connected to an associate appliance lid. An arm control system includes a spring rod engaged with the base and adapted to move relative to the base in a sliding reciprocal manner along a spring rod axis. A spring exerts a biasing force on the spring rod that urges the spring rod toward an extended position, wherein the spring rod is movable against the biasing force from the extended position toward a retracted position. The arm is operatively engaged with the spring rod of the arm control system through an arm control linkage such that: (i) pivoting movement of the arm in an opening direction corresponds with movement of the spring rod from the retracted position toward the extended position; and, (ii) pivoting movement of the arm in a closing direction opposite the opening direction corresponds with movement of the spring rod from the extended position toward the retracted position.

In accordance with a further aspect of the present development, a damper is connected to the base and exerts a damping force on the spring rod or other part of the arm control system when the arm moves in a closing direction.

In accordance with a further aspect of the present development, an appliance lid hinge assembly includes a base, an arm pivotally connected to the base, an arm control system including a sliding spring rod and a biasing spring system that acts resiliently between the spring rod and the base, and an arm control linkage pivotally connected to the arm and engaged with the spring rod to operatively connect the arm to the biasing spring system.

### BRIEF DESCRIPTION OF THE DRAWINGS

FIG. 1A partially illustrates a clothes washer, clothes dryer, or other household appliance including at least one hinge assembly provided in accordance with the present development;

FIG. 1B is a partial side view of the appliance of FIG. 1A;

FIG. 2 is a right-side isometric view of a hinge assembly according to an embodiment of the present development, with the hinge assembly arranged in an intermediate operative position corresponding to the intermediate opened position of the associated appliance lid;

FIG. 3 is similar to FIG. 2 but provides a partial left-side isometric view of the hinge assembly;

FIG. 4 is a top view of the hinge assembly of FIGS. 2 and 3;

FIG. 5 is a section view taken at cutting plane 5-5 of FIG. 4;

FIG. 6 is a section view similar to FIG. 5 but shows the hinge assembly in a fully closed (first operative) position corresponding to a fully closed position of the associated appliance lid;

FIG. 7 is a section view similar to FIG. 5 but shows the hinge assembly in a fully opened (second operative) position corresponding to a fully opened position of the associated appliance lid;

FIG. 8 is an isometric view of an alternative embodiment of a hinge assembly formed in accordance with the present development;

FIG. 9 is a side section view of the hinge assembly of FIG. 8;

FIGS. 10A & 10B are side views of another alternative embodiment of a hinge assembly provided in accordance with the present development, with the hinge assembly being positioned in its fully closed (first operative) and fully opened (second operative) positions, respectively.

### DETAILED DESCRIPTION

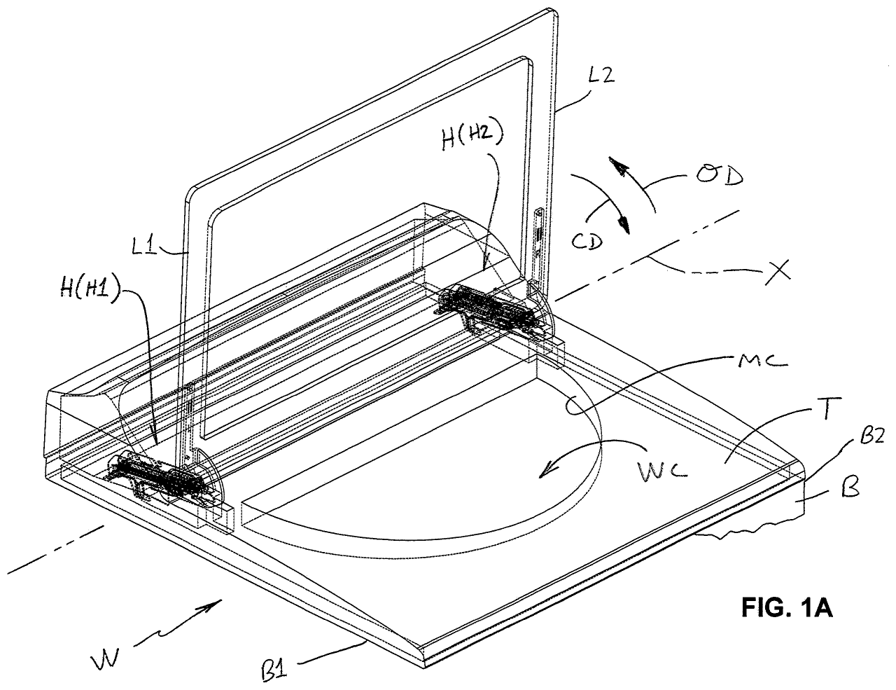

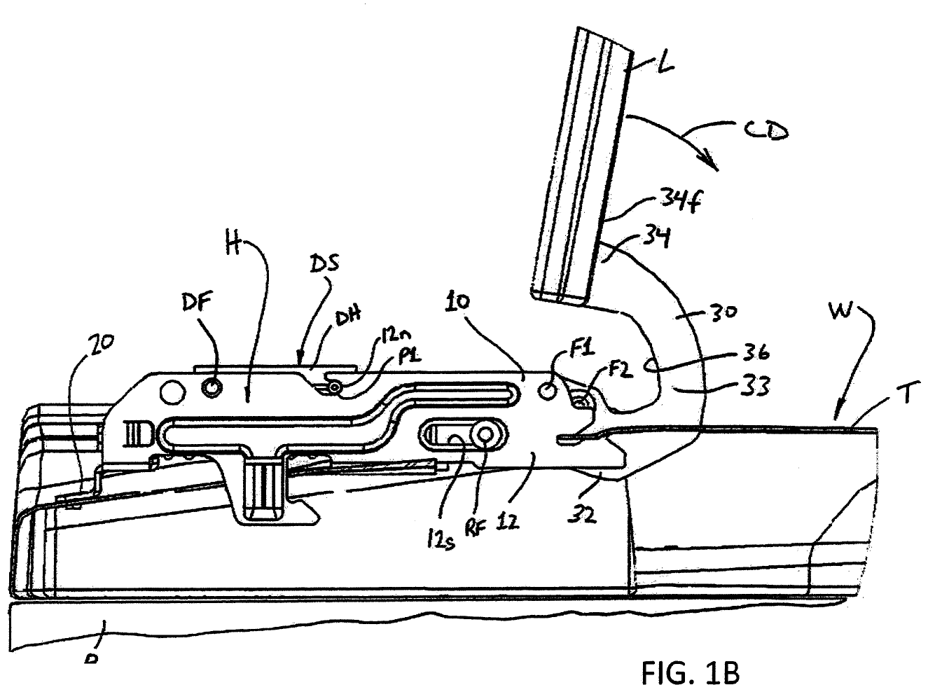

FIGS. 1A & 1B each partially illustrate a clothes washer, clothes dryer, or other household appliance W that comprises a body B that includes or defines a washing, drying or other appliance chamber WC. The chamber WC comprises an access opening or mouth MC that opens through a wall of the body B. In the non-limiting example of FIGS. 1A & 1B, the mouth MC of the chamber WC opens through the top wall T of the body B, but the mouth MC can open through any other wall of the body B.

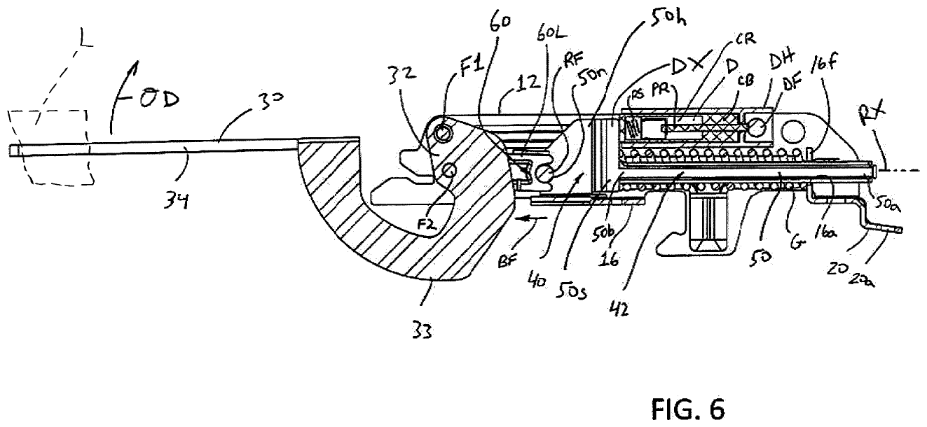

The appliance W further comprises a lid L that is pivotally connected to the body B by one or more hinges or hinge assemblies H such as the first (left) and second (right) hinge assemblies H1,H2 that are respectively located adjacent opposite first (left) and second (right) lateral sides of the lid L and chamber WC. The one or more hinge assemblies H1,H2 operatively connect the lid L to the body B such that the lid L pivots about a main pivot axis X between an opened position in which the lid L is pivoted away from the mouth MC in an opening direction OD to allow access to the chamber WC via mouth MC, and a closed position (not shown in FIGS. 1A & 1B, see FIG. 6) in which the lid L is pivoted in an opposite, closing direction CD to a position where the lid L lies adjacent the top or other wall T through which the mouth MC opens so that the lid L covers the mouth MC and blocks access to the chamber WC via mouth MC. The main pivot axis X is horizontally oriented in the example of FIGS. 1A & 1B, but the main pivot axis X can be vertically or otherwise oriented depending upon the orientation of the wall of the body B in which the chamber mouth MC is located.

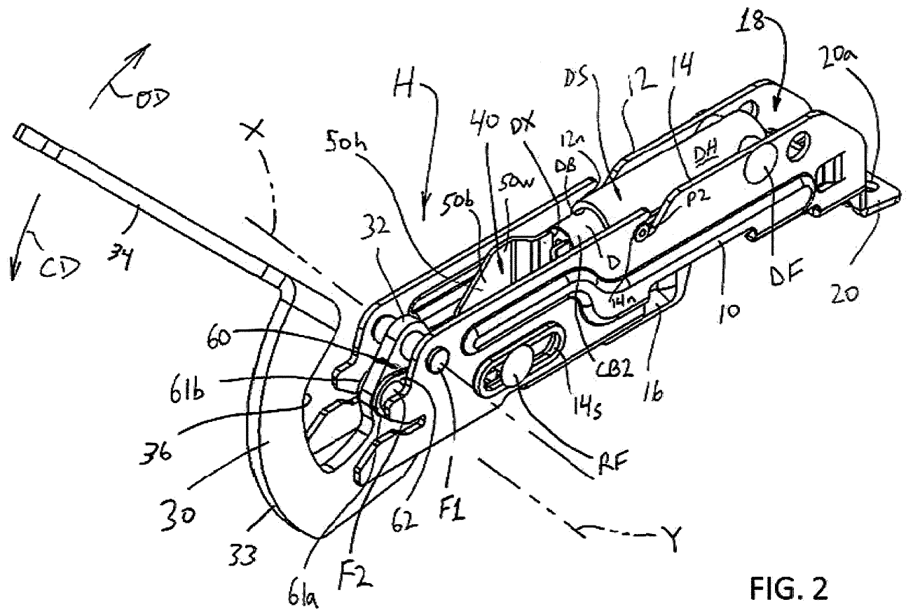

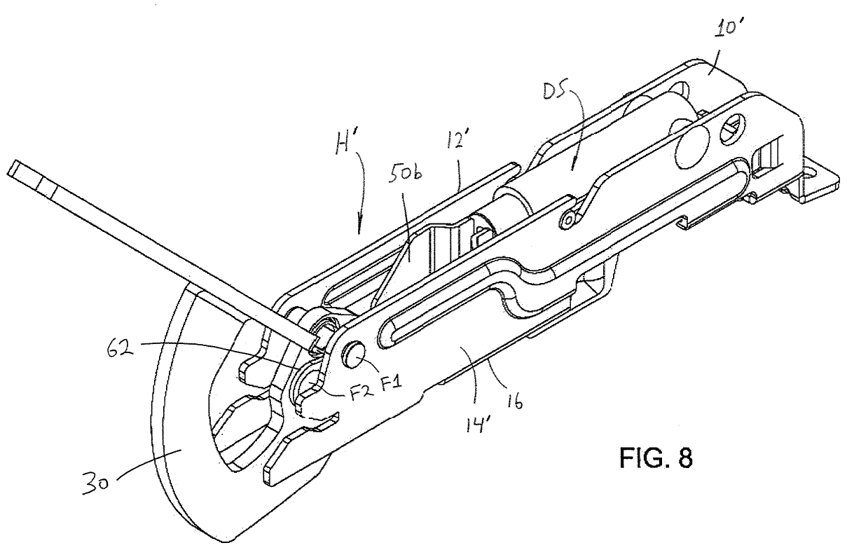

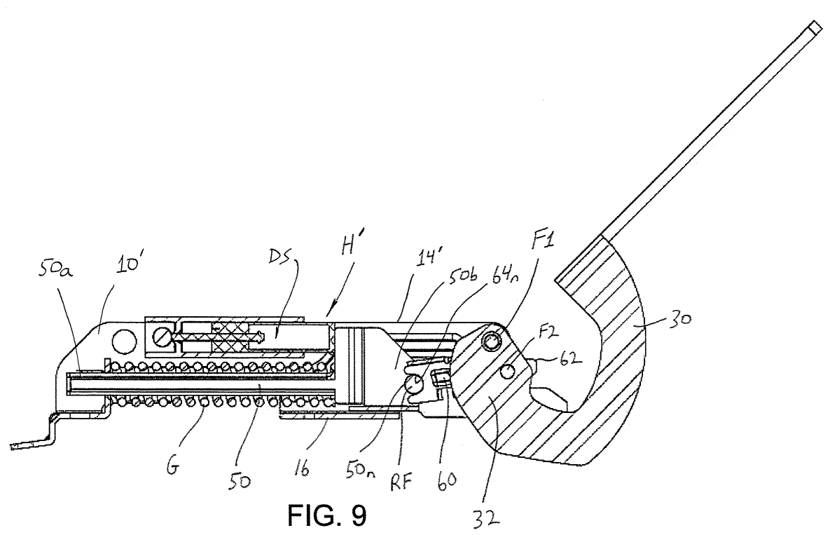

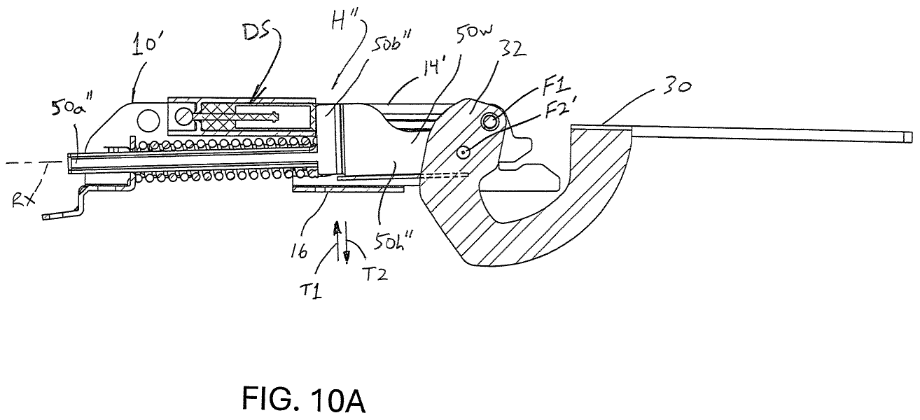

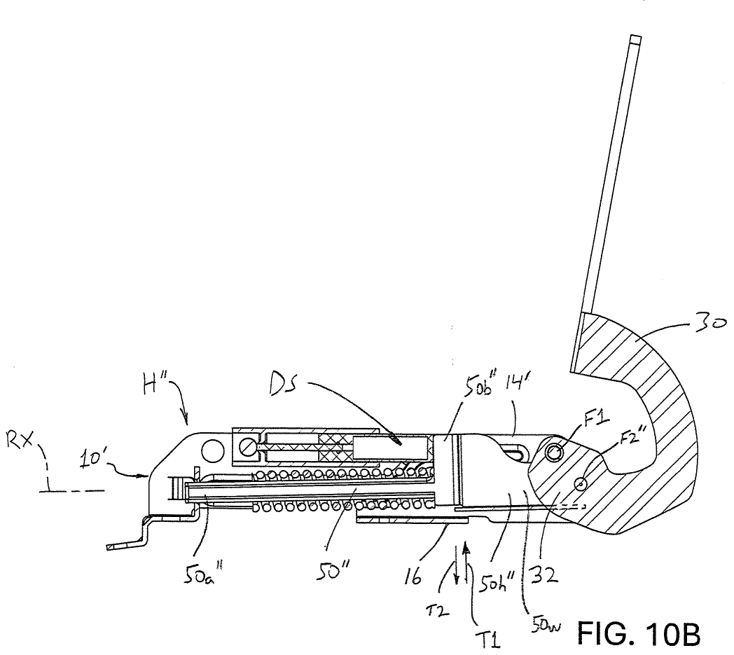

The hinge assemblies H1,H2 are respectively connected adjacent opposite first (left) or right (second) lateral sides B1,B2 of the appliance body B and chamber WC and are also respectively connected adjacent opposite first (left) and second (right) lateral sides L1,L2 of the lid L. In the example of FIGS. 1A & 1B, at least one of the first and second hinge assemblies H1,H2 and preferably both of the hinge assembly H1,H2 are constructed and provided in accordance with an embodiment of the present development as shown by the hinge assembly H in FIGS. 2-7, and/or by the hinge assembly H′ of FIGS. 8 & 9, and/or by the hinge assembly H″ of FIGS. 10A & 10B. Depending upon the particular appliance W on which the hinge assemblies H1,H2 are to be installed, the first and second hinge assemblies H1,H2 can be distinct from each other in the sense that the first hinge assembly H1 can be specifically configured for being mounted on the first or left lateral side of the appliance body B and lid L and the second hinge assembly H2 can be specifically configured for being mounted on the second or right lateral side of the appliance body B and lid L. Alternatively, in certain applications, the first and second hinge assemblies H1,H2 can be identical, i.e., the hinge assembly H of FIGS. 2-7 can be ambidextrous in the sense that the hinge assembly H1,H2 can be mounted on either the first or left lateral side of the appliance body B and lid L (as the hinge assembly H1) or on the second or right lateral side of the appliance body B and lid L (as the hinge assembly H2) interchangeably.

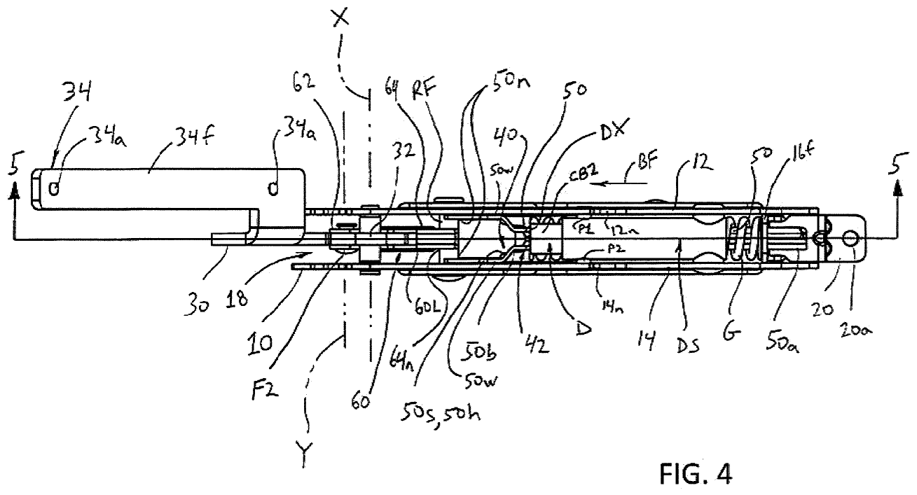

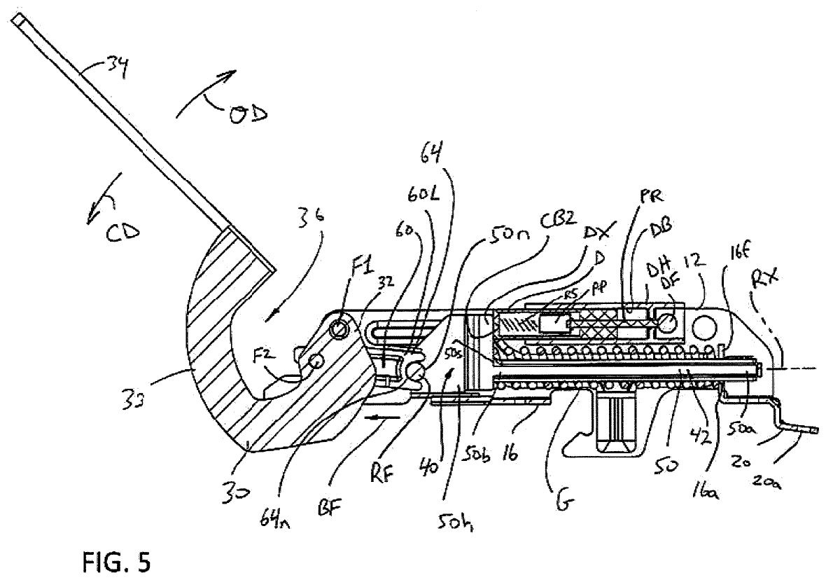

FIGS. 2 & 3 respectively provide right-side and left-side isometric views of a hinge or hinge assembly H provided in accordance with an embodiment of the present development. FIG. 4 is a top view of the hinge assembly H. The hinge assembly H can be configured as either the first hinge assembly H1 or the second hinge assembly H2 (as shown), or the hinge assembly H can be universal or ambidextrous and be configured to function as both the first hinge assembly H1 and the second hinge assembly H2. In FIGS. 2 & 3, the hinge assembly H is arranged or configured in an intermediate (third) operative position corresponding to the intermediate or partially opened (third) operative position of the associated appliance lid L between its fully opened (second) operative position and its fully closed (first) operative position. FIG. 5 provides a section view of the hinge assembly Has taken at the cutting plane 5-5 of FIG. 4. FIGS. 6 & 7 are section views that are similar to FIG. 5, but respectively show the hinge assembly H in first and second operative positions corresponding to the fully closed (first) and fully opened (second) operative positions of the associated appliance lid L.

In one non-limiting example, the intermediate (third operative) opened position of the lid L is provided when the lid L is located or arranged at an angle of more than 0 degrees and less than 80 degrees relative to the top wall T or other wall in which the mouth MC is defined (such as 45 degrees as shown), and the fully opened position of the appliance lid L can be defined as a position where the lid L is pivoted a maximum distance away from the appliance wall T and mouth MC of the chamber C. In one non-limiting example, the fully opened position of the appliance lid L can be defined as a position where the lid L is pivoted 80 degrees (or more) away from the appliance wall T and mouth MC of the chamber C or 90 degrees (or more) away from the appliance wall T and mouth MC of the chamber C or more than 90 degrees in some cases. As noted above, in the closed or fully closed position, the lid L is abutted with or otherwise located adjacent the top wall T or other wall in which the mouth MC is defined so that the lid L covers the mouth MC and blocks access to the chamber WC and so that the lid L defines an angle of 0 degrees relative to the top wall T or other wall.

Referring to all of FIGS. 2-7, the hinge assembly H comprises a base 10 adapted to be connected to the appliance body B adjacent the chamber mouth MC as shown in FIGS. 1A & 1B. In the illustrated example, the base 10 comprises a one-piece structure provided by a metal stamping or similar structure, although the base 10 can alternatively or additionally comprise a multi-piece metallic structure or a one-piece or multi-piece molded polymeric structure or any other suitable material or combination of materials. The base 10 comprises parallel, spaced-apart first and second side walls 12,14 and at least one connecting wall 16 that extends transversely between and connects the first and second side walls 12,14. An open channel or space 18 is thus defined between the spaced-apart first and second side walls 12,14 and the connecting wall 16. The base 10 also comprises one or more mounting tabs 20 each of which may include a slot or other aperture 20a or other structure by which the base 10 can be secured to the appliance body B or other associated structure using suitable fasteners and/or by a sliding or other mating mechanical connection.

The hinge assembly H further comprises an arm 30 that is pivotally connected to the base 10 using a main pivot fastener F1 such as a rivet, stud, pin, or other suitable fastener that can optionally include a bushing, sleeve, or other member as a part thereof. The arm 30 rotates about the main pivot fastener F1 and about the main pivot axis X, i.e., the main pivot axis X is coincident with the center of the main pivot fastener F1. In the illustrated example, an inner end 32 of the arm 30 is located in the space 18 between the first and second side walls 12,14 of the base 10 adjacent an outer end of the base, and the main pivot fastener F1 extends through both side walls 12,14 and through the arm 30, with the opposite first and second ends of the main pivot fastener F1 respectively supported by the first and second sidewalls 12,14, such that the main pivot fastener F1 operatively connects the arm 30 to the base 10 and operatively supports the arm 30 for angular rotation relative to the base 10 about the pivot axis X in the first (opening) direction OD and an opposite second (closing) direction CD.

The arm 30, which is preferably provided as a one-piece stamped or other one-piece metal structure, comprises an inner end or inner portion 32 located adjacent the base 10 and through which the main pivot fastener F1 extends. The arm 30 further comprises an opposite outer end or outer (mounting) portion 34 that is connected to and projects outwardly away from the inner portion 32 and away from the base 10 and main pivot fastener F1. Between its inner end 32 and the outer mounting portion 34, the arm 30 preferably comprises a U-shaped central or middle region 33 where the arm 30 is curved and includes a bend 36 to accommodate and provide clearance for portions of the appliance body B that would otherwise be contacted by the arm 30 when the lid L is moved toward its fully opened position. The associated appliance lid L is operatively connected to the mounting portion 34 of the arm 30 by any suitable mechanical connection, e.g., using rivets, screws, a mating mechanical connection, and/or using fasteners that extend through one or more apertures 34a that may be located in a mounting flange 34f of the mounting portion 34 (FIG. 4). In the illustrated example, the hinge assembly H is configured as the second hinge assembly H2 to be mounted on the right lateral side of the appliance body B and lid L, but those of ordinary skill in the art will recognize that the illustrated hinge assembly H can alternatively be configured to be mounted on the left lateral side of the appliance body B and lid L without departing from the scope and intent of the present development, e.g., by reversing the direction in which the mounting flange 34f projects transversely outward from the arm 30 or by otherwise reconfiguring the arm 30 and/or body 10 to fit in the available mounting space.

The hinge assembly H further comprises an arm control subassembly or arm control system 40 connected to the base 10 and operatively engaged with the arm 30 for exerting a biasing force on and controlling movement of the arm 30 when the arm 30 is rotated or pivoted about the main pivot fastener F1 in the opening and/or closing directions OD,CD during movement of the appliance lid L to and between its closed and opened positions. The arm control system 40 comprises a biasing spring system 42 including a spring rod 50 slidably engaged with the base 10 and a biasing spring G operatively engaged with the spring rod 50. The spring rod 50 includes a first or outer end 50a and an opposite second or inner end 50b. The spring rod 50 can be provided as a one-piece metal structure or multi-piece fabricated metal structure or can alternatively be provided as a polymeric structure or a combination of the foregoing materials. In the illustrated embodiment, the connecting wall 16 of the base 10 comprises an upturned mounting flange 16f located in the space 18 between the first and second side walls 12,14 of the base and that includes an aperture 16a through which the spring rod 50 extends and in which the spring rod 50 is slidably located. The first or outer end 50a of the spring rod 50 is located on an outer side of the mounting flange 16f and the second or inner end 50b of the spring rod is located on an inner side of the mounting flange 16f in the space 18 defined between the first and second side walls 12,14.

In the illustrated embodiment of FIGS. 2-7, the spring rod 50 is restricted to reciprocal linear sliding movement along its longitudinal spring rod axis RX relative to the base 10. In this example, the opposite first and second side walls 12,14 of the base include respective elongated slots 12s, 14s (FIGS. 2 & 3) that are aligned or registered with each other and that are elongated along respective axes that lie parallel to the spring rod axis RX. In the illustrated embodiment, the opposite first and second ends of a spring rod fastener or rod fastener RF (or rod pin RF) are respectively located in the first and second elongated slots 12s, 14s so that the slots 12s, 14s allow reciprocal sliding movement of the rod fastener RF and a second (inner) end 50b of the spring rod 50 that is connected to or otherwise engaged directly or indirectly with the rod fastener RF along the spring rod axis RX but prevent movement of the rod fastener RF and spring rod 50 in a direction transverse to the spring rod axis RX. In the present example, the first and second opposite ends of the rod fastener RF extend through and are captured in the first and second elongated slots 12s, 14s, respectively. The rod fastener RF can comprise a rivet, stud, pin, or other suitable fastener that can optionally include a bushing, sleeve, or other member as a part thereof.

In the illustrated example, the inner end 50b of the spring rod 50 includes at least one open recess or notch 50n (see FIGS. 4-7) in which the rod fastener RF is seated or otherwise engaged to operably engage or operably connect the inner end 50b of the spring rod 50 with the rod fastener RF. The rod fastener RF can alternatively extend through one or more closed slots or apertures defined in the inner end 50b of the spring rod 50.

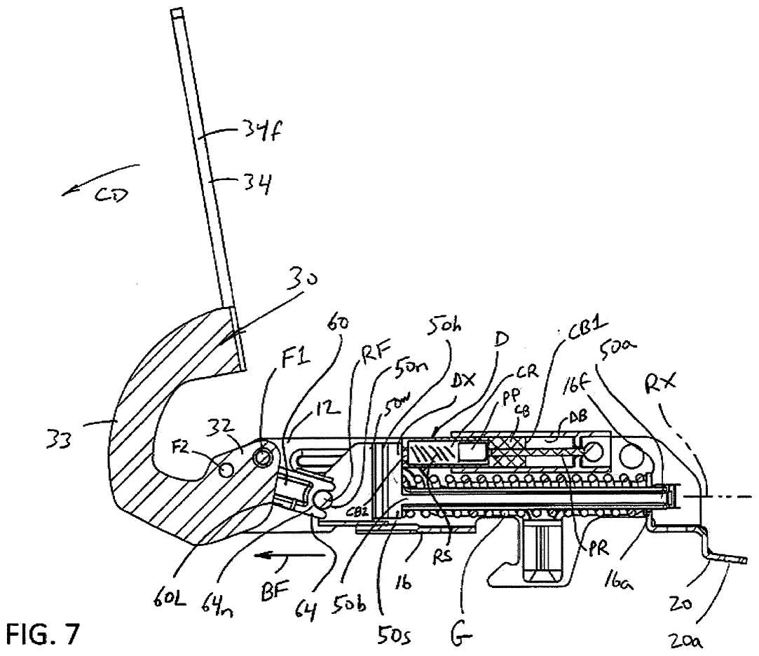

The spring rod 50 moves to and between a retracted position (FIG. 6) in which the second (inner) end 50b of the spring rod 50 is moved away from the main pivot fastener F1 toward the mounting flange 16f and an extended position (FIG. 7) in which the second (inner) end 50b of the spring rod 50 is moved away from the mounting flange 16f toward the main pivot fastener F1 such that the inner end 50b of the spring rod 50 is located closer to the mounting flange 16f and farther from the main pivot fastener in the retracted position as compared to the extended position. As such, the opposite, first or outer end 50a of the spring rod 50 is spaced farther from the mounting flange 16f in the retracted position as compared to the extended position. The extended position of the spring rod 50 corresponds to the hinge assembly H being in its second operative (opened) position as shown in FIG. 7 corresponding to the associated appliance lid L being fully opened. The retracted position of the spring rod 50 corresponds to the hinge assembly H being in its first operative (closed) position as shown in FIG. 6 corresponding to the associated appliance lid L being fully closed. As noted above, FIG. 5 shows an intermediate operative (third) position of the hinge assembly H corresponding to the associated appliance lid L being located in an intermediate position between its fully closed and fully opened positions. The side wall slots 12s, 14s in the base 10 limit the magnitude and direction of movement of the rod fastener RF and thus correspondingly limit movement of the spring rod 50 as it moves in a reciprocal manner along the spring rod axis RX to and between its extended and retracted positions.

The second or inner end 50b of the spring rod 50 can include a spring stop 50s that comprises an enlarged head 50h or other portion of the spring rod 50, and/or that comprises a separate member such as a cross-pin or other structure connected to and/or provided as part of the spring rod second end 50b. The biasing spring system 42 further comprises a biasing spring G operably engaged between the spring rod 50 and base 10 that biases the spring rod 50 toward its extended (lid-opened) position. In the illustrated example, the biasing spring G comprises a helical coil spring coaxially positioned about the spring rod 50 so that the spring rod 50 extends through the open center core of the coil spring G. The coil spring G is captured between the spring stop 50s at the second (inner) end 50b of the spring rod 50 and the mounting flange 16f or other part of the base 10, and the spring G is thus configured as a compression spring operably engaged between the spring rod 50 and the base 10 in which resilient lengthening of the spring G establishes a biasing force BF that is exerted on the spring rod 50 and that continuously urges the second end 50b of the spring rod away from the mounting flange 16f toward the arm 30 and main fastener F1 and, thus, continuously urges the spring rod 50 toward its extended position. Movement of the spring rod 50 toward and into its retracted position against this biasing force BF toward the retracted position of the spring rod resiliently shortens and compresses the spring G between the spring stop 50s and the mounting flange 16f or another fixed portion of the base 10. The spring G also ensures that the inner end 50b of the spring rod 50 is always continuously biased into engagement with the rod fastener RF so that the rod fastener RF is continuously firmly seated in the one or more recesses or notches 50n located on the inner end 50b of the spring rod 50.

As noted above, the biasing spring system 42 is part of an arm control system 40 that is operatively engaged with the arm 30 between the arm 30 and base 10 for exerting a biasing force on and controlling movement of the arm 30 when the arm 30 is rotated or pivoted about the main pivot fastener F1 relative to the base in the opening and/or closing directions OD,CD during movement of the appliance lid L to and between its closed and opened positions. In the illustrated embodiment of FIGS. 2-7, the arm 30 is operatively engaged with the biasing spring system 42 through an arm control linkage 60 that can form part of the arm control system 40. The arm control linkage 60 extends between and operatively connects the arm 30 to the spring rod 50. The illustrated arm control linkage 60 comprises a first end 62 pivotally connected to the arm 30 by a secondary pivot fastener F2 at a link pivot location that is offset from the main pivot fastener F1. The first end 62 of the arm control linkage 60 pivots relative to the arm 30 about a link pivot axis Y that is parallel to but offset from the main pivot axis X (see FIG. 4) such that the first end 62 of the arm control linkage 60 is eccentrically mounted relative to the main pivot axis X. An opposite, second end 64 of the arm control linkage 60 is operatively engaged with the spring rod 50. In the illustrated non-limiting example, the second end 64 of the arm control linkage 60 is operatively engaged with the spring rod 50 through the rod fastener RF such as by being abutted with the rod fastener RF (as shown) or is connected to the rod fastener RF, or the second end 64 of the arm control linkage 60 can be otherwise operatively engaged with the spring rod 50 such as by being engaged directly with the enlarged head 50h or other part of the inner end 50b of the spring rod 50. The second end 64 of the arm control linkage 60 can be abutted with or fixedly secured to the rod fastener RF (or other part of the biasing spring assembly 42). In the illustrated example, the second end 64 of the arm control linkage 60 includes at least one open receiving recess or notch 64n that is conformed and dimensioned to receive the rod fastener RF therein such that the rod fastener RF (and remainder of the biasing spring assembly 42) is operatively engaged with the arm control linkage 60 and with the arm 30 through the arm control linkage 60. The biasing force BF of the spring G is exerted on the rod fastener RF through the spring rod 50 such that the rod fastener RF remains firmly seated in the open receiving notch 64n of the arm control linkage 60 for all operative positions of the arm 30 and biasing spring system 42. The use of the open receiving notch 64n facilitates assembly of the hinge assembly H in that it eliminates the need to pivotally secure the second end 64 of the arm control linkage 60 to the rod fastener RF by extending the rod fastener RF through a closed aperture formed in the second end 64 of the arm control linkage 60, although such a pivoting connection or similar between the second end 64 of the arm control linkage and the rod fastener RF (or other part of the biasing spring assembly 42) can alternatively be used in an embodiment of the hinge assembly H and is within the scope and intent of the present development.

In the illustrated example, the arm control linkage 60 comprises a single rigid link 60L, but multiple interconnected links can also be used to define the control linkage 60. The arm control linkage 60 converts linear motion of the spring rod 50 into rotational motion of the pivoting arm 30 and vice versa. The single link 60L (or multiple interconnected links 60L) can each be formed as shown herein or otherwise. In the illustrated example, the link 60L comprises a one-piece metallic construction but it can comprise a multi-piece assembly of metal and/or other materials such as polymeric materials. In one example, the link 60L is formed as a metal stamping but it can alternatively be cast, extruded, or otherwise formed. The illustrated link comprises a double-walled structure including first and second spaced-apart link walls 61a,61b (FIGS. 2 & 3) that are interconnected by a connecting wall. The first and second link walls 61a,61b define a space between themselves in which the arm 30 is closely received. The open receiving notch 64n at the second end 64 of the link 60L is defined by first and second aligned notch portions 61n (see also FIG. 4) defined respectively in the first and second link walls 61a,61b.

As shown at H′ in FIGS. 8 & 9, in an alternative embodiment of a hinge assembly formed in accordance with the present development the slots 12s, 14s of the base 10 are omitted to provide the alternative base 10′ with side walls 12′,14′ without the slots 12s, 14s. The rod fastener RF is operatively engaged with the inner end 50b of the spring rod 50 in the same or similar manner as described above for the hinge assembly embodiment H of FIGS. 2-7, but the rod fastener/pin RF is not engaged with any slots defined in the walls 12,14 or other part of the base 10. Except as otherwise shown and/or described herein, the hinge embodiment H′ is the same as the hinge embodiment H described above.

Another alternative embodiment is shown at H″ in FIGS. 10A & 10B and is similar to the embodiment H′ (and can use the base 10′ as described above) but the arm control linkage 60 is eliminated and the arm 30 is instead operative engaged directly with the inner end 50b″ of the spring rod 50″ such as by the arm 30 being engaged directly with the enlarged head 50h″ or other part of the inner end 50b″ of the spring rod 50″. In the illustrated example, the inner end 32 of the arm 30 is pivotally connected directly to the spring rod head 50h″ by the secondary pivot fastener F2″ that is connected to and extends between the spaced-apart side walls 50w of the spring rod head 50h″. Those of ordinary skill in the art will recognize, in this embodiment the spring rod 50″ is required to float or move transversely (up & down) relative to base 10′ as indicated by the arrows T1,T2 toward and away from the base connecting wall 16 due to the offset between the secondary pivot fastener F2″ and the main pivot axis X and main pivot fastener F1. Except as otherwise shown and/or described herein, the hinge embodiment H″ is the same as the hinge embodiment H′ described above.

In all embodiments, the arm control system 40 including the biasing spring system 42 is operatively engaged with the arm 30 for exerting a biasing force BF on and controlling movement of the arm 30 when the arm 30 is rotated or pivoted about the main pivot fastener F1 in the opening and/or closing directions OD,CD during movement of the appliance lid L to and between its closed and opened positions and intermediate positions there between. The biasing force BF urges the arm 30 in the opening direction OD and resists movement of the arm 30 in the closing direction CD.

In use, the biasing spring system 42 continuously biases the spring rod 50 toward its extended position, which results in the spring rod 50 continuously urging the arm 30 in the opening direction OD through the arm control linkage 60. Manual pivoting movement of the associated appliance lid L about the main pivot axis X in the opening direction OD from its closed position toward its fully opened position or in the opposite closing direction CD from the opened position toward the closed position causes rotation of the hinge assembly arm 30 about the pivot axis X in the corresponding opening direction OD or closing direction CD and alters the location of the arm control linkage 60 which, in turn, alters and controls the position of the second (inner) end 50b of the spring rod 50 on the spring rod axis RX so that: (i) the spring rod 50 is moved by the biasing force BF of the spring G from its retracted position toward its extended position when the associated appliance lid L and arm 30 move in the opening direction OD; and (ii) the spring rod 50 is moved from its extended position toward its retracted position against the biasing force BF of the spring G when the associated appliance lid L and arm 30 move in the closing direction CD. The biasing force BF of the spring G acts: (i) to assist in movement of the associated appliance lid L from its closed position toward its opened position; (ii) to slow movement of the associated appliance lid L from its opened position toward its closed position to resist high-speed contact between the lid L and the appliance body B at the fully closed position; and (iii) to provide a counterbalance mechanism that counteracts the weight of the lid L to hold the associated lid L stationary in an intermediate counterbalance position between its fully opened and fully closed positions when the biasing force BF is exactly counteracted or counterbalanced by an equal and opposite force exerted on the spring rod 50 through the arm connector linkage 60 due to gravity acting on the lid L in the closing direction CD.

At least one of the hinge assemblies H, i.e., the hinge assembly H1 and/or the hinge assembly H2, can comprise a damper system DS arranged and configured to damp movement of the associated appliance lid L as the appliance lid moves in the closing direction CD from an opened position toward and into the closed position to prevent or at least inhibit forceful closing or “slamming” of the lid L against the appliance body B when the lid L moves to its closed position. The damper system DS can comprise a damper D connected to the base 10 and located to be engaged and activated by the any one or more of the arm 30, the spring rod 50, and/or any other part of the arm control system 40, or another structure connected to or moved by any of the same, during movement of the appliance lid L in the closing direction CD to dampen and slow movement of the arm 30 and lid L in the closing direction. In the non-limiting example of the illustrated embodiment, the damper system DS comprises a damper housing DH that is connected to the base 10. The damper housing DH comprises a molded polymeric or other structure that is located in the space 18 between the side walls 12,14 adjacent the spring rod 50 and that is fixedly secured to the base 10 using a damper fastener such as a rivet or the like DF that extends through both base side walls 12,14 and through the damper housing DH. The base 10 can include one or more tabs, grooves, flanges, slots or other structures for engaging the damper housing DH for assisting with locating and securing the damper housing DH in its operative position. For example, as shown, the first and second side walls 12,14 of the base respectively include first and second undercut damper housing support notches 12n, 14n that respectively receive, capture, and retain first and second damper housing support pins P1,P2 that project outwardly from opposite lateral sides of the damper housing DH such that when the damper fastener DF is installed after the first and second damper housing support pins are installed in the respective notches 12n, 14n, the damper housing DH is immovably captured to and installed on the base 10 by the damper fastener DF and by engagement of the pins P1,P2 in the respective notches 12n, 14n.

In the illustrated embodiment, the damper D is operably engaged with and supported by the damper housing DH. The damper housing DH includes a damper support bore DB in which the damper D is operably located. In this example, the damper support bore DB extends along a bore axis that is offset from and parallel to the spring rod axis RX, but it can be coaxial with or otherwise oriented relative to the spring rod axis RX.

The damper D, itself, comprises a damper cylinder or damper cylinder body CB that includes a cylinder bore CR in which a piston PP is slidably supported for reciprocal sliding movement between an extended position (FIG. 7) and a retracted position (FIG. 6). FIG. 5 shows a partially retracted position of the piston PP between the extended and retracted positions. A piston rod PR includes an inner end connected to the piston PP and an opposite outer end that extends outwardly from the cylinder bore CR at a first end CB1 of the cylinder body. The cylinder body CB also includes a closed second end CB2 located opposite the first end CB1. When the piston PP is extended the piston rod PR projects outwardly from the body first end CB1 a greater extent as compared to when the piston PP is retracted. When the piston PP is retracted, it is moved away from the body first end CB1 and toward the body second end CB2 so that the piston rod PR is correspondingly retracted into the cylinder bore CR and projects outwardly from the body first end CB1 a lesser extent as compared to when the piston PP is in its extended position. The extended and retracted positions of the piston PP correspond respectively to extended and retracted positions or states of the damper D.

In the illustrated example, the cylinder body CB is located in the damper support bore DB of the damper housing DH, and the cylinder body CB is reciprocally slidable or movable in the damper support bore DB. In the present embodiment, the cylinder body CB slidably reciprocates in the damper support bore DB on an axis coincident with the spring rod axis RX, and the piston PP moves between its extended and retracted positions along a damper axis that is coincident with the spring rod axis RX. As shown herein, the damper D is arranged with its piston rod PR oriented toward the damper fastener DR and with the second end CB2 of the cylinder body CB projecting outwardly from the damper support bore DB toward the main pivot fastener F1. The outer end of the piston rod PR can be abutted with the damper fastener DR and the second end CB2 of the cylinder body can be abutted with the part of the spring rod 50 for all operative positions of the arm 30. The orientation of the damper D in the damper support bore DB can optionally be reversed so that the piston rod PR projects toward the main pivot fastener F1 and so that the second end CB2 of the cylinder body CB is located in the damper support bore DB and oriented toward with the damper fastener DR, in which case the outer end of the piston rod PR can be abutted with a part of the spring rod 50 and the second end CB2 of the cylinder body can be abutted with the damper fastener DR for all operative positions of the arm 30.

A gas or liquid damping fluid and/or a mechanical damping spring is contained in the cylinder bore CR and acts on the piston PP to damp its movement from the extended position toward the retracted position. Preferably, the piston PP is configured such that the damping fluid damps movement of the piston PP to a greater extent when the piston is moving from its extended position toward its retracted position as compared to the opposite direction of movement of the piston to facilitate a faster return or “reset” of the piston PP from its retracted position to its extended position. The illustrated damper P includes a mechanical return spring such as a coil spring RS within the bore CR that acts between the piston PP and the damper cylinder body CB to urge the piston PP from its retracted position toward its extended position when the damper D is not under load, i.e., to urge the cylinder body CB outwardly toward the spring rod 50 in the illustrated orientation of the damper. The return spring RS can alternatively be positioned externally located relative to the cylinder bore CR and coaxially positioned about the piston rod PR between the first end CB1 of the cylinder body and a cap or spring stop connected to or formed as part of the outer end of the piston rod PR to bias the piston PP to its extended position relative to the cylinder body CB.

The hinge assembly H comprises a damper actuator DX that is connected to or otherwise operably engaged with and/or provided as a part of the second (inner) end 50b of the spring rod 50 so that the damper actuator moves with the spring rod when the spring rod 50 reciprocates along the spring rod axis RX between its extended and retracted positions. In the illustrated embodiment of the hinge assembly H, the damper actuator is provided by part of the spring stop 50s which comprises an enlarged head 50h connected to and/or provided on the second end 50b of the spring rod 50. Thus, when the spring rod 50 reciprocates, the damper actuator DX reciprocates therewith and actuates the damper D as described below. As shown herein, the enlarged head 50h located at the second (inner) end 50b of the spring rod 50 comprises a bifurcated structure including first and second parallel spaced-apart walls 50w that fits closely between to the base side walls 12,14 to minimize lateral movement of the spring rod 50. The walls 50w of the enlarged spring rod head 50h comprise respective open notches 50n (see FIG. 4) in which the rod fastener RF is seated (these open notches 50n can alternatively be formed as closed apertures through which the rod fastener RF extends).

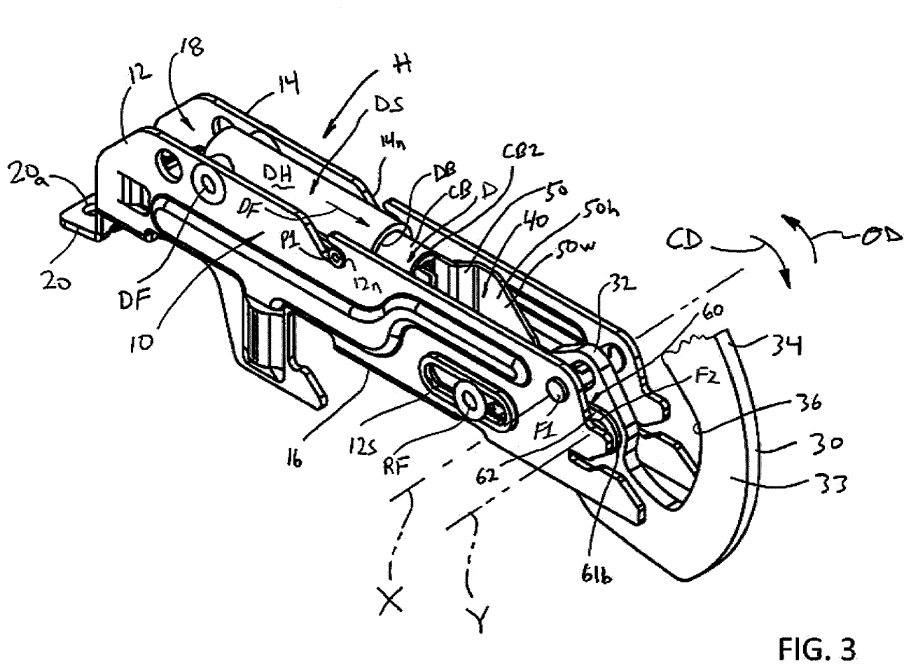

When the arm 30 is pivoted in the closing direction CD during movement of the appliance lid L from an opened position toward the closed position, the damper actuator DX located on the second end 50b of the spring rod engages and activates the damper D such as by urging the cylinder body CB inward relative to the piston PP and causing the piston PP to move toward its retracted position and the damper D to move toward its retracted condition when the spring rod 50 moves from its extended position toward its retracted position. In this case, the damper D exerts an opposite damping force DF (FIG. 3) against the damper actuator DX portion of the spring rod 50 that slows and damps movement of the spring rod 50 from its extended position toward its retracted position. As such, the damping force DF slows movement of the appliance lid L in the closing direction CD to reduce the force with which the lid L contacts the body B when the lid reaches its closed position. When the lid L is manually opened by movement in the opening direction OD, the damper actuator DX of the spring rod 50 moves away from the damper fastener DF so that the damper D can reset (return to its configuration in which the piston PP and piston rod PR are extended) when the damper return spring RS moves the cylinder body CB outwardly away from the piston PP to place the piston in its extended position and to place the damper D in its extended condition.

The development has been described with reference to preferred embodiments. Modifications and alterations will occur to those of ordinary skill in the art to which the invention pertains, and it is intended that the claims be construed as broadly as possible while maintaining their validity in order to encompass all such modifications and alterations.

1. An appliance lid hinge assembly comprising:
a base;
an arm pivotally connected to the base and adapted to be connected to an associated appliance lid;
an arm control system comprising a spring rod engaged with the base and adapted to move relative to the base in a sliding reciprocal manner;
a spring that exerts a biasing force on the spring rod that urges the spring rod toward an extended position, wherein said spring rod is movable against the biasing force from the extended position toward a retracted position;
said arm operatively engaged with the spring rod such that: (i) pivoting movement of the arm in an opening direction corresponds with movement of the spring rod toward the extended position; and, (ii) pivoting movement of the arm in a closing direction opposite the opening direction corresponds with movement of the spring rod toward the retracted position.

2. The appliance lid hinge assembly as set forth in claim 1, wherein said base comprises opposite spaced apart first and second side walls that comprise respective first and second elongated slots that are registered with each other, and wherein a rod fastener is slidably engaged with both said first and second elongated slots and an inner end of said spring rod is operably engaged with said rod fastener such that said spring rod moves linearly relative to said base along a spring rod axis.

3. The appliance lid hinge assembly as set forth in claim 1, further comprising a damper connected to said base and adapted to be engaged by and exert a damping force on said arm control system when said arm moves in said closing direction.

4. The appliance lid hinge assembly as set forth in claim 3, wherein said damper is engaged by said spring rod of said arm control system when said spring rod moves toward its retracted position.

5. The appliance lid hinge assembly as set forth in claim 3, wherein said damper comprises a piston that moves between an extended position and a retracted position along an axis that is offset from and parallel to the spring rod axis.

6. The appliance lid hinge assembly as set forth in claim 4, wherein said inner end of said spring rod comprises an enlarged head comprising a damper actuator for engaging said damper, said enlarged head comprising a bifurcated structure including first and second spaced-apart walls to that are each engaged with said rod fastener.

7. The appliance lid hinge assembly as set forth in claim 1, wherein said arm is operatively engaged with the spring rod through an arm control linkage comprising a first end connected to the arm and comprises a second end that is operably engaged with the spring rod.

8. The appliance lid hinge assembly as set forth in claim 7, wherein said arm pivots relative to said base about a main pivot axis, and wherein said first end of said arm control linkage is pivotally connected to the arm and pivots relative to said arm about a link pivot axis that is parallel to but offset from the main pivot axis.

9. The appliance lid hinge assembly as set forth in claim 8, wherein said arm control linkage comprises a single link or multiple interconnected links.

10. The appliance lid hinge assembly as set forth in claim 1, wherein:
said arm pivots relative to said base about a main pivot axis; and
said spring rod is directly pivotally connected to said arm by a secondary pivot fastener that is offset from said main pivot axis.

11. The appliance lid hinge assembly as set forth in claim 10, further comprising a damper connected to said base and adapted to be engaged by and exert a damping force on said arm control system when said arm moves in said closing direction.

12. The appliance lid hinge assembly as set forth in claim 11, wherein said damper is engaged by said spring rod of said arm control system when said spring rod moves toward its retracted position.

13. The appliance lid hinge assembly as set forth in claim 12, wherein said damper comprises a piston that moves between an extended position and a retracted position along an axis that is offset from the spring rod axis.

14. The appliance lid hinge assembly as set forth in claim 13, wherein said inner end of said spring rod comprises an enlarged head comprising a damper actuator for engaging said damper, said enlarged head comprising a bifurcated structure including first and second spaced-apart walls that are each engaged with said secondary pivot fastener.

15. An appliance lid hinge assembly including a base, an arm pivotally connected to the base, an arm control system including a sliding spring rod and a biasing spring system that acts resiliently between the spring rod and the base, and an arm control linkage pivotally connected to the arm and engaged with the spring rod to operatively connect the arm to the biasing spring system.

16. The appliance lid hinge assembly as set forth in claim 15, further comprising a damper system that acts on the biasing spring system to slow movement of the arm relative to the base.
